(19) United States
(12) Patent Application Publication
(10) Pub. No.: US 2012/0151991 A1
(43) Pub. Date: Jun. 21, 2012

(54) Exhaust Gas Analyzer

(75) Inventor: Stephan Ester, Bad Wuenneberg (DE)

(73) Assignee: Wohler Messgerate Kehrgerate GmbH, Bad Wuenneberg (DE)

(21) Appl. No.: 12/808,576

(22) PCT Filed: Jun. 23, 2008
(86) PCT No.: PCT/DE2008/001010

§ 371 Date: Sep. 28, 2011

(30) Foreign Application Priority Data
Dec. 17, 2007 (DE) 10 2007 061 143.0

(51) Int. Cl. G01N 7/06

(52) U.S. Cl. 73/23.31

(57) ABSTRACT

A flue gas analyzer device which can be held in one hand and which has a probe barrel for drawing in a gas sample with a pump, a thermocouple arranged in the probe barrel, and with a housing receiving a battery-powered evaluating and measuring device. A pump chamber, a condensate chamber, a condensate separator, and the probe barrel are arranged axially one behind the other in front of a handle of the pistol-shaped housing of the analyzer device. The gas sample is drawn in from the condensate chamber via an exchangeable filter device by the pump arranged in the pump chamber and is supplied for analysis to sensors arranged in the handle via a line.

### PRIORITY CLAIM

This is a U.S. national stage of application No. PCT/EP2008/001010, filed on Jun. 23, 2008, which claims priority to the German Application No.: 10 2007 061 143.0, filed: Dec. 17, 2007, the content of both incorporated herein by reference.

### BACKGROUND OF THE INVENTION

1. Field of the Invention

The invention is directed to a flue gas analyzer device that can be held in one hand having a probe barrel for drawing in a gas sample a pump, a thermocouple arranged in the probe barrel, and a housing receiving a battery-powered evaluating and measuring device for carrying out measurements and calculations for assessing heating installations.

2. Related Art

It is necessary to carry out measurements in heating installations on a regular basis to comply with the general administrative regulations for the ordinance for implementing the Federal Emissions Control Act governing furnaces with liquid and gaseous combustibles (1st BImSchV). To this end, it is known. from DE 196 11 463 to arrange a probe barrel provided with a sheathed thermocouple for acquiring temperature in a gas flowing in a chimney. A gas sample which is drawn up by a separately constructed analyzer device flows through the probe barrel and then through a tube to the actual analyzer device. Sealing problems regularly occur due to the complexity of the connection from the probe barrel to the actual analyzer, specifically also by the flexibility achieved in the connection. Further, handling of the analyzer device in its entirety is inconvenient, especially when the connection tubes are comparatively long. Another typical disadvantage in devices of the type mentioned above is related to design and consists in that a flue, gas that has been drawn in cools off within the tube or connection pieces leading to the analyzer device and can lead to condensation inside the tube. If this condensate penetrates into the analyzer device, the measuring cells located therein for acquiring the concentration of oxygen and carbon monoxide are destroyed.

DE 24 11 834 A1 discloses a flue gas analyzer device in which a probe barrel is connected in the region of its end remote of the inlet opening to a grip piece that resembles a pistol grip and extends substantially transverse to the longitudinal direction of the probe barrel. In the area of the inlet opening, the probe barrel has an electric temperature sensor connected by a measuring line to a measuring and evaluating device set back from the grip piece with the probe barrel.

Opposite the inlet opening, the probe barrel is connected by a first connection tube to a condensation device arranged in the grip piece. This condensation device is formed by an elongated hollow space oriented substantially vertically in operation and which has an inlet opening in a bottom area and an outlet opening in a top area for a gas sample. This gas sample is guided, via a second connection tube connected to the outlet openings, to the offset evaluating and measuring device for further measurement.

DE 20 2004 009 615 U1 discloses an analyzer device with a pistol-like housing from which a flexible probe barrel projects. The probe barrel has a flexible tube which serves as a through-line for a gas sample. This tube is enclosed by a jacket made from a different material, and a helical spring is arranged at least partially inside the tube.

A generic flue gas analyzer device that has found great commercial success is described in DE 198 55 831 A1. In this case, a probe barrel which is rigid against bending projects from a substantially square housing. A condensate separator is arranged below the end of the probe barrel on the housing side. For this reason, the volume flow of a gas sample must be deflected multiple times. Owing to the flow resistance caused by this, a comparatively high-power pump is required so that power consumption is not optimal. Also, the arrangement of the display elements and operating controls of the device on a flat side is disadvantageous in ergonomic respects.

There is a wide variety of other known, successful embodiment forms of condensation devices for separating liquids from gases. Specific embodiment forms are shown in EP 0864862 A2, DE 41 01 194 C1, and DE 86 25 127 U1.

### SUMMARY OF THE INVENTION

One embodiment of the invention provides a convenient, ergonomically designed analyzer device for measuring a plurality of physical characteristics, particularly of a flue gas, in which flow losses are substantially prevented.

In a flue gas analyzer device, which can be held in one hand, has a probe barrel for drawing in a gas sample with a pump, a thermocouple arranged in the probe barrel, and a housing receiving a battery-powered evaluating and measuring device, in that a pump chamber, a condensate chamber, a condensate separator, and the probe barrel are arranged axially one behind the other in front of a handle of the pistol-shaped housing of the analyzer device, and in that the gas sample is drawn in from the condensate chamber via an exchangeable filter device by the pump arranged in the pump chamber and is supplied for analysis to sensors arranged in the handle via a line.

The flue gas analyzer device according to one embodiment of the invention has a range of advantages over the devices known from the prior art. Accordingly, the entire evaluating and measuring device is received in a handle of a housing which can be held at this handle in the shape of a pistol. One-hand operation is made possible in a simple manner in this way, and handling is substantially facilitated by the low center of gravity of the device when held in the hand.

Comparatively lightweight components are arranged axially one behind the other in front of the handle, namely, in direction of the handle, the probe barrel, the condensate separator, the condensate chamber, and the pump chamber with pump. In spite of the structural length resulting from the axial arrangement, the path of a gas sample is comparatively unimpeded because of the axial arrangement.

The heavy structural component parts, in particular the sensor arrangement in its entirety, a circuit board holding the electric/electronic circuit of the evaluating and measuring device, and the preferably rechargeable batteries for the power supply, are arranged inside the handle. A low center of gravity of the flue gas analyzer device according to one embodiment of the invention is achieved so that it can be held securely in the hand and can also be operated easily with the same hand when a transition from an upper side of the pump chamber to a rear side of the handle is shaped to be inclined and the housing is closed by a display and control arrangement. This display and control arrangement is preferably a screen, and preferably an LCD display, on top with a key pad below it which can then be operated by the thumb of the hand holding the handle of the flue gas analyzer device.

Generally, at least two batteries, preferably storage batteries connected in series are provided for the power supply. A parallel connection with two additional batteries, also connected in series, doubles the available power capacity. In this regard, in the flue gas analyzer device according to one embodiment of the invention, at least two batteries which are connected in series, for example, one behind the other axially, can be arranged in the handle, and the batteries can then be accessed through a flap on the handle, preferably on the front side of the handle. A heavy battery pack such as occurs in battery-powered screw drivers, for example, can be avoided, although an arrangement of batteries known therefrom, e.g., as removable battery pack with a particularly high capacity, below the actual handle or as a base rest is also possible.

In particular, if a base rest of the type mentioned above is provided, it has magnets arranged at its outer side so that the analyzer device according to the invention can easily be fixed, e.g., to a boiler wall for adjustment work.

Because the sensors only have a limited lifetime due to aging, sensors arranged in the handle are accessible through a flap and can be exchanged depending on operation in another preferable embodiment.

In another embodiment, the probe barrel comprises a flexible stainless steel corrugated pipe. Flexible stainless steel pipes can be heated up to 800° C. without problems so that it is also possible to measure comparatively hot flue gases with the analyzer device according to one embodiment of the invention.

In another embodiment, a helical thermocouple is arranged centrally in the probe barrel and is preferably held in a clamp-like manner so as to be centered by a cap arranged at the free end of the probe barrel.

Further, the condensate separator can narrow in diameter conically toward the probe barrel. Annular and/or helical grooves extending around the outer circumference of the condensate separator can be covered in a gastight manner by a portion of the housing which narrows in diameter in a corresponding manner. A simply designed, but extremely efficient, construction of the condensate separator is provided in this way because a separate housing is not needed for covering the grooves and it is possible for the annular and/or helical grooves of the condensate separator and the inner, conforming surface of the housing to form a gastight heat exchanger.

In another embodiment, the housing can terminate on the front side by a flange which is T-shaped in longitudinal section, the probe barrel can be caught in a central through-opening of the flange, and the flange can be held by its center foot in a central recess of a projection which axially lengthens the condensate separator.

This substantially rotationally symmetric, coaxial arrangement of the thermocouple, probe barrel, penetrated fastening flange, projection of the condensate separator, and adjoining housing is very compact, but is mechanically stable and, when fabricated, e.g., from plastic, is relatively problem-free.

### BRIEF DESCRIPTION OF DRAWINGS

The analyzer device according to the invention will be described more fully with reference to the drawings which schematically show only one embodiment example. The drawings show:

FIG. 1 is a side view of the analyzer according to one embodiment of the invention;

FIG. 2 is a top view of the analyzer according to one embodiment of the invention;

FIG. 3 is a perspective view of the analyzer according to one embodiment of the invention;

FIG. 4 is a section according to line IV-IV in FIG. 2;

FIG. 5 is a handle with base rest of the analyzer according to one embodiment of the invention; and

FIG. 6 is an enlarged view of the free end of the probe barrel.

### DETAILED DESCRIPTION OF THE PREFERRED EMBODIMENTS

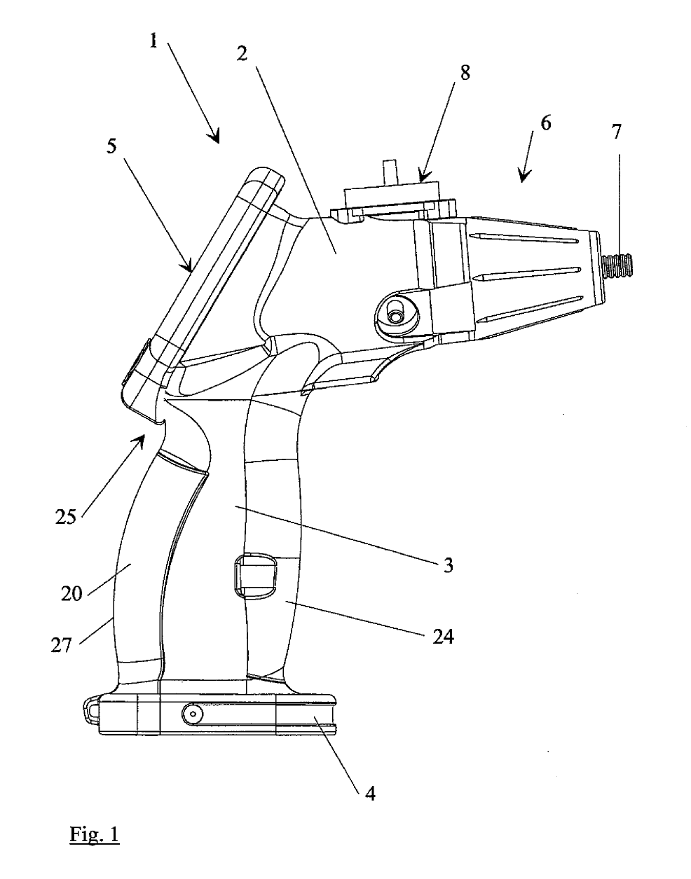

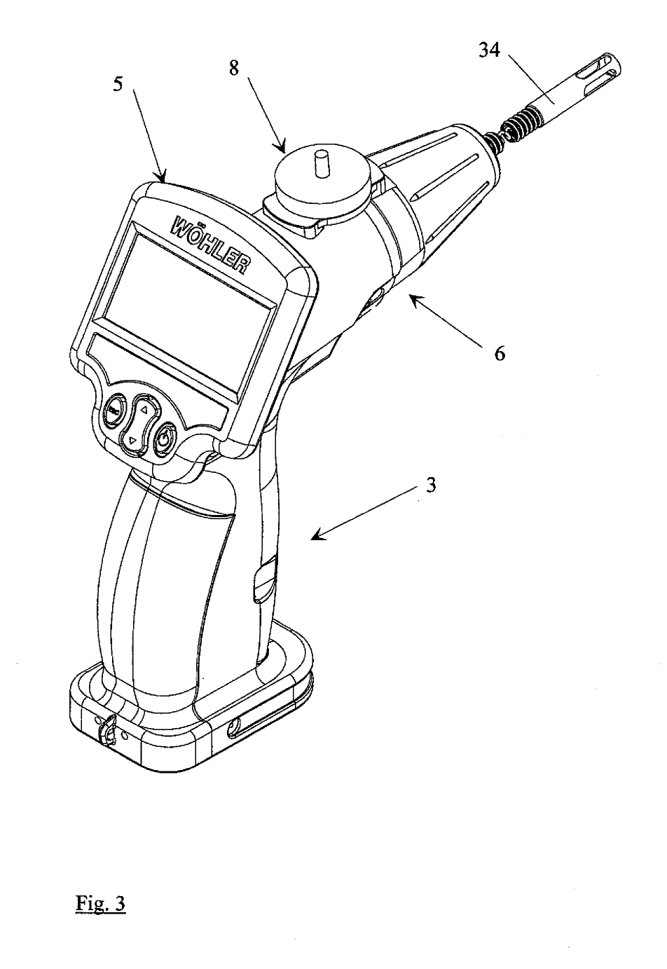

The drawings show a flue gas analyzer device 1 by way of example which does not resemble battery-powered screw drivers that are known roughly by their appearance in FIGS. 1-4, the housing 2 is pistol-shaped and has a handle 3, a base rest 4, a display and control arrangement 5, and a housing portion 6 which lies in front of the handle 3 and which continues into a probe barrel 7 which is shown in abbreviated form in the drawing. At the top, the housing portion 6 has a filter device 8 which is easily accessible and exchangeable.

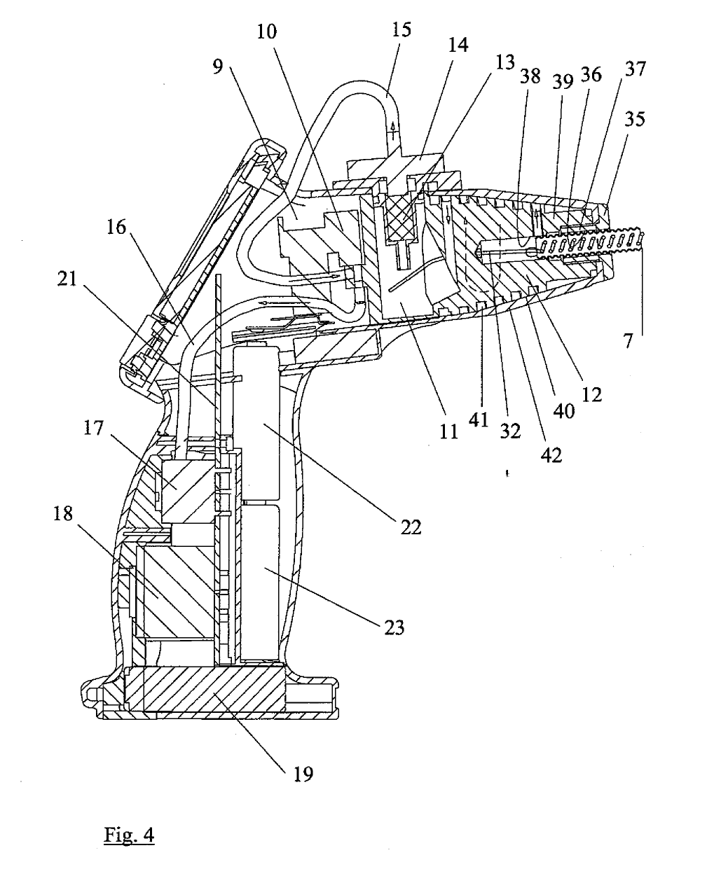

The section according to FIG. 4 shows that a pump chamber 9 with pump 10, a condensate chamber 11, a condensate separator 12, and the probe barrel 7 are arranged axially one behind the other in front of the handle 3.

As is indicated by the arrows, a gas sample drawn in through the probe barrel 7 by the pump 10 passes through the condensate separator 12 into the condensate chamber 11. The gas sample is drawn in through the filter device 8, which is constructed in one embodiment as a two-stage filter with a cotton filter 13 and a PTFE filter 14, by the pump 10 via a line 15, e.g., a tube, and is fed to sensors 17, 18, 19 for analysis via an additional line 16, once again a tube or possibly also a pipeline.

The sensors 17-19 arranged in the handle 3 are accessible through a flap 20 in the handle 3 so that they can be exchanged, for example, because of aging or the like.

Also arranged in the handle 3 are the operating electronics which are indicated on a circuit board 21. The power supply is ensured by at least two, preferably rechargeable, batteries 22, 23 which are connected in series and can likewise be accessed through a flap 24 on the front of the handle 3.

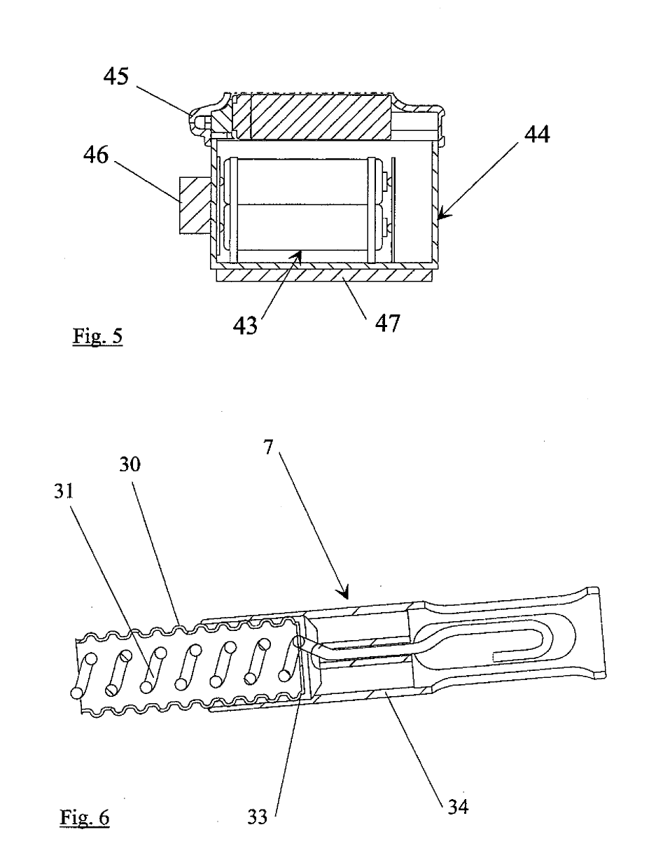

An alternative for the power supply is a battery pack 43 (see FIG. 5) by which a base rest 44 can be formed in a manner known per se corresponding to conventional battery-powered screw drivers. A battery pack 43 of this kind can be formed in such a way that it can be removed in its entirety along with the base rest 44 from the handle, not shown in more detail in FIG. 5, or can be accessed through flaps in the base rest 43. In addition to an eyelet 45 for securing to a cord, a chain, or the like, the base rest 44 has external, lateral and/or bottom magnets 46, 47 so that the analyzer device can be fixed to metal objects, e.g., a boiler wall, during a prolonged analysis.

The display and control arrangement 5 forms a diagonally extending transition 25 from an upper side 26 of the pump chamber 9 to a rear side 27 of the handle 3 and has a display 28, preferably in the form of an LCD screen. In the present instance, three operating controls 29 are sufficient for menu-controlled handling.

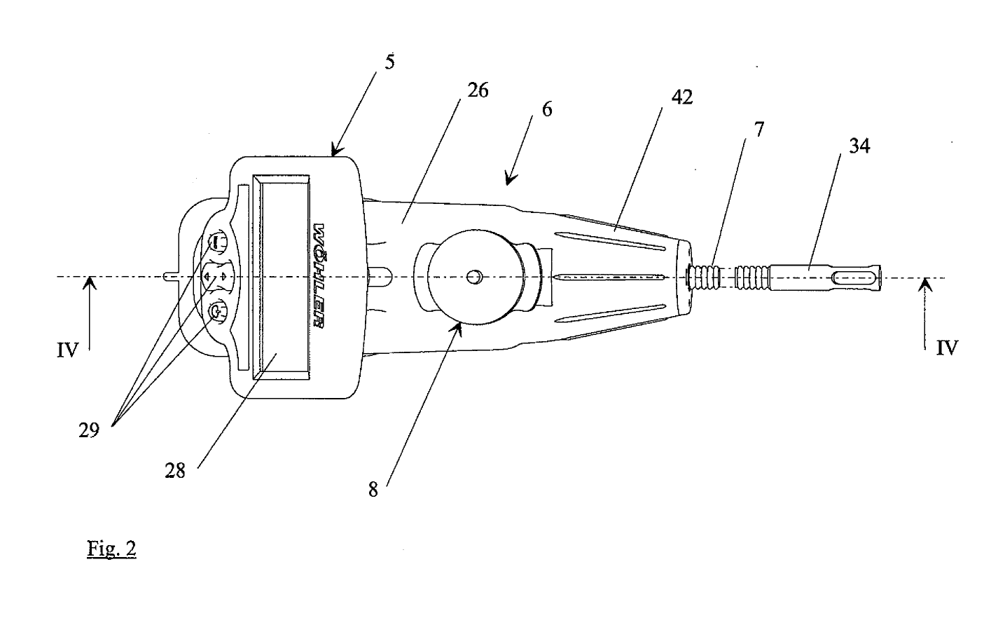

FIG. 4 and particularly the enlarged view in FIG. 6 show that the probe barrel 7 is substantially formed by a flexible stainless steel corrugated pipe 30. A helical thermocouple 31 is centrally arranged in the probe barrel 7. At one end, the thermocouple 31 is connected via a line 32 to the electronics on the circuit board 21 and, at the other end, is held so as to be centered in a clamp-like manner by a cap 34 which is arranged at the free end 33 of the probe barrel 7. (FIGS. 2, 4, and 6).

On the housing side, the probe barrel 7 is held in a central through-opening 36 by a flange 35 which terminates the housing 2 on the front side and is T-shaped in longitudinal section. The base 37 of the flange 35 is secured in a central recess 38 of a projection 39 which axially lengthens the condensate separator 12. Subsequent to the projection 39 toward the handle 3, the diameter of the condensate separator 12 increases and the conical upper side 40 of the condensate separator 12 has circumferential annular and/or helical grooves 41 which are covered directly by a conical portion 42 of the housing 3 which narrows in diameter toward the probe barrel 7.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A flue gas analyzer device configured to be held in one hand, comprising:
a pump;
a probe barrel for drawing-in a gas sample by the pump;
a thermocouple arranged in the probe barrel;
a pistol-shaped housing configured to receive a battery-powered evaluating and measuring device;
a condensate separator axially behind the probe barrel;
a condensate chamber arranged axially behind the condensate separator;
an exchangeable filter device arranged between the condensate chamber and the pump;
a pump chamber configured to house the pump arranged axially behind the a condensate chamber;
a handle of the pistol-shaped housing arranged axially behind the pump chamber;
a plurality of sensors arranged in the handle;
a line configured to couple the plural sensors to the pump such that the gas sample that is drawn in from the condensate chamber through the exchangeable filter device by the pump arranged in the pump chamber is provided to the plural sensors.

13. The flue gas analyzer device according to claim 12, further comprising a display and control arrangement, wherein a transition from a vertically arranged upper side of the pump chamber to a rear side of the handle is shaped so as to be inclined, and in that the housing is closed by the display and the control arrangement.

14. The flue gas analyzer device according to claim 12, wherein at least two series connected batteries are arranged in one of the handle or a base rest of the handle.

15. The flue gas analyzer device according to claim 12, wherein the plural sensors are accessible through a flap and are configured to be exchanged.

16. The flue gas analyzer device according to claim 12, wherein at least one magnet is arranged on an outer side of at least one of the handle and a base rest of the handle.

17. The flue gas analyzer device according to claim 12, wherein the probe barrel comprises a flexible stainless steel corrugated pipe.

18. The flue gas analyzer device according to claim 12, further comprising a helical thermocouple arranged centrally in the probe barrel.

19. The flue gas analyzer device according to claim 18, further comprising a cap arranged at a free end of the probe barrel that retains the thermocouple centered in a clamp-like manner.

20. The flue gas analyzer device according to claim 12, wherein
the condensate separator narrows in diameter conically toward the probe barrel, and
one of annular grooves and helical grooves extending around an outer circumference of the condensate separator that are covered in a gastight manner by a portion of the housing which narrows in diameter in a corresponding manner.

21. The flue gas analyzer device according to claim 20, wherein the one of the annular grooves and the helical grooves of the condensate separator and the inner conforming surface of the housing form a gastight heat exchanger.

22. The flue gas analyzer device according to claim 12, further comprising a T-shaped flange in longitudinal section configured to terminate a front probe barrel end of the housing, wherein the probe barrel is arranged in a central through-opening of the T-shaped flange.

23. The flue gas analyzer device according to claim 17, wherein a helical thermocouple is arranged centrally in the probe barrel.

24. The flue gas analyzer device according to claim 14, wherein the at least two series connected batteries are at least one of accessible through a flap and removable with the base rest as a battery pack.

25. The flue gas analyzer device according to claim 22, wherein a center portion of the T-shaped flange is arranged in a central recess of a projection that axially lengthens the condensate separator.
